(19) United States
(12) Patent Application Publication
(10) Pub. No.: US 2014/0282738 A1
(43) Pub. Date: Sep. 18, 2014

(54) REMOTE TRIGGER COMMAND TO RECALL COMPLEX NAVIGATION

(71) Applicant: GENERAL INSTRUMENT CORPORATION, Horsham, PA (US)

(72) Inventor: James M. Hunter, San Jose, CA (US)

(73) Assignee: GENERAL INSTRUMENT CORPORATION, Horsham, PA (US)

(21) Appl. No.: 13/841,192

(22) Filed: Mar. 15, 2013

(51) Int. Cl. H04N 21/482

(52) U.S. Cl. CPC H04N 21/482
USPC 725/52

(57) ABSTRACT

In one embodiment, a method receives a trigger initiation command for configuring a trigger command and receives the trigger command from a trigger device that is separate from the computing device. The trigger command is based on a selection of a trigger command input on the trigger device. Then, the method determines a state of a complex navigation that requires multiple actions to output content associated with the state. An association is stored between the state of the complex navigation and the trigger command. The method receives the trigger command from the trigger device where the trigger command is sent based on a single input selecting the trigger command input. Then, the state of the complex navigation is recalled to output the content.

### BACKGROUND

Users may access content through a variety of different media. For example, a user may be watching a television (TV) show or movie that includes a character the user would like to know more information about. The user may then use a secondary device, such as a tablet device, to perform a search for the character. For example, the user may search for other TV shows or movies in which the character appears. In one example, the user may enter a search query into a search engine, which returns a search result including a set of movies or TV shows.

Based on the search result, the user may want to preview another movie in which the character appears. In this case, the user may pause the current movie, and then start playing the new movie that includes the character. To play the new movie, the user may have to navigate a menu system to find the new movie or download the new movie to watch it. At some point, the user may want to go back and resume watching the original movie. In this case, it is possible that the user may not be able to return to the original point at which the user stopped watching the original movie. For example, the user may not have saved the position in the original movie. In other cases, the user may have saved the position in the movie, and can navigate a menu system to retrieve the movie and resume playing it. However, to resume playing the movie, the user has to take multiple navigation steps through the menu system.

At another point in time, the user may want to review the search result for the character. However, the search result for the search that the user had performed most likely is still not active. For example, as time passes, users typically navigate to other webpages, perform other searches, etc. To re-perform the search, a user typically inputs in the same search terms as used before to re-perform the search. In this case, a multi-step process is performed to navigate to the search engine, remember the search terms used, and input the search terms. Again, performing the above actions requires that a user to perform multiple navigation steps, which may be tedious.

### BRIEF DESCRIPTION OF THE DRAWINGS

FIG. 1 depicts a system for configuring a trigger command to recall a complex navigation according to one embodiment.

FIG. 2 depicts a simplified flowchart of a method for storing a trigger command according to one embodiment.

FIG. 3 depicts a simplified flowchart of a method for recalling a complex navigation according to one embodiment.

FIG. 4 depicts a more detailed example of a set-top box according to one embodiment.

FIG. 5 depicts an example of the information stored for the state of the complex navigation according to one embodiment.

FIG. 6 shows a system for recalling the state of a complex navigation performed on a second computing device according to one embodiment.

FIG. 7 illustrates an example of a special purpose computer system configured with a trigger command configuration system according to one embodiment.

### DETAILED DESCRIPTION

Described herein are techniques for a trigger command configuration system. In the following description, for purposes of explanation, numerous examples and specific details are set forth in order to provide a thorough understanding of particular embodiments. Particular embodiments as defined by the claims may include some or all of the features in these examples alone or in combination with other features described below, and may further include modifications and equivalents of the features and concepts described herein.

In one embodiment, a method receives a trigger initiation command for configuring a trigger command and receives the trigger command from a trigger device that is separate from the computing device. The trigger command is based on a selection of a trigger command input on the trigger device. Then, the method determines a state of a complex navigation that requires multiple actions to output content associated with the state. An association is stored between the state of the complex navigation and the trigger command. The method receives the trigger command from the trigger device where the trigger command is sent based on a single input selecting the trigger command input. Then, the state of the complex navigation is recalled to output the content.

In one embodiment, a non-transitory computer-readable storage medium contains instructions that, when executed, control a computer system to be configured for: receiving a trigger initiation command for configuring a trigger command; receiving the trigger command from a trigger device separate from the computing device, the trigger command based on a selection of a trigger command input on the trigger device; determining a state of a complex navigation, the complex navigation requiring multiple actions to output content associated with the state; storing an association between the state of the complex navigation and the trigger command; receiving the trigger command from the trigger device, the trigger command being sent based on a single input selecting the trigger command input; and recalling the state of the complex navigation to output the content.

In one embodiment, a method includes: receiving, by a computing device, a first input for a trigger initiation command for configuring a trigger command; sending, by the computing device, the trigger initiation command to a secondary device; receiving, by the computing device, a second input for the trigger command, the trigger command based on a selection of a trigger command input; sending, by the computing device, the trigger command to the secondary device, wherein the secondary device saves a state of a complex navigation requiring multiple actions to output content associated with the state and the secondary device associates the state with the trigger command; receiving, by the computing device, a third input for the trigger command, the trigger command based on a single input selecting the trigger command input; and sending, by the computing device, the trigger command to the secondary device, wherein the secondary device recalls the state of the complex navigation to output the content based on the receiving of the trigger command.

FIG. 1 depicts a system 100 for configuring a trigger command to recall a complex navigation according to one embodiment. FIG. 1 includes a trigger device 102 and an output device 104. Output device 104 includes various configurations to output content. For example, output device 104 may include a display device 106, such as a television, monitor, tablet device, or personal computer. A set-top box 108 or over-the-top (OTT) box may be coupled to display device 106. Set-top box 108 may receive content from a content provider 110 (e.g., a head end, server, etc.) through a network 113 and display the content on display device 106. Content providers 110 may provide different types of content. For example, content may include web pages; media programs, such as television shows, movies, videos; and pictures. Set-top box 108 will be referred to for discussion purposes, but the functionality described with respect to set-top box 108 may be incorporated into display device 106 or distributed among multiple devices. Additionally, when set-top box 108 is discussed, the discussion applies to an OTT box also. The OTT box delivers services that are not under control of a service provider delivering content to the set-top box 108 (i.e., content delivered through the Internet).

In one embodiment, set-top box 108 may receive a first instance of content and a second instance of content from content providers 110 (e.g., different content providers) and output the first instance of content and the second instance of content on user interface 114. In other embodiments, as will be described later, the first instance of content and the second instance of content may be displayed on a secondary device.

A user may perform a complex navigation that may involve multiple actions. In one example, a user may perform different actions to navigate to different instances of content. For example, a first window 112-1 displays a first instance of content on a user interface 114. The first instance of content may be a movie that is being watched by the user and may be at a certain point in the movie, such as the user may have watched an hour of the movie. A second window 112-2 displays a second instance of content on user interface 114. The second instance of content may be any type of content, such as the same type as the first instance of content, such as the user may be watching a television show. Additionally, the second instance of content may also be different from the first instance of content, such as the second instance of content may be a search result for a search that the user performed using a search engine in a web browser. In both cases, a user performed multiple actions to display the first instance of content and the second instance of content. With respect to the first instance of content, the user may have navigated a menu system in a first application to search for and find the movie, select the movie, and then cause the movie to start playing. For the second instance of content, the user may have opened a second application, such as a web browser, inputted a search query, performed the search, and received a search result.

In another example, the complex navigation may involve only one instance of content, but requires multiple actions to open the content. For example, a user may launch an application, search for a movie, and start playing the movie on a TV. Also, a user may launch a web browser, input a search, and perform the search. Although the following discussion may reference multiple instances of content for a complex navigation, the complex navigation may be performed for just one instance of content. Additionally, although only two instances of content are discussed, the complex navigation may involve more than two instances of content.

After performing the complex navigation, the user may want to save the complex navigation that was performed. Due to the first instance of content and the second instance of content being displayed in different windows 112/different applications, conventionally, the user would have had to save the position of the first instance of content in the first application and save the position of the second instance of content in the second application. For example, the user may pause the movie in the first application. Also, the user can save a bookmark for a webpage containing a search result in a web browser. To recall the above complex navigation, the user would have to perform many steps even though the user paused the movie and bookmarked the webpage. For example, the user would have to open the first application, find the movie in a menu system, select the movie, and then send a command to resume playing of the movie. Additionally, the user would then open up a web browser, find the bookmark, and select the bookmark. In contrast to requiring the user to perform multiple actions, particular embodiments provide a user the ability to save a complex navigation where the complex navigation can be recalled using a single trigger command.

In one embodiment, trigger device 102 may have an trigger command input 116 that can be used to send a trigger command to recall the complex navigation. Trigger device 102 may be a remote control, such as a television remote control, or another device that is paired with set-top box 108 (i.e., can communicate with set-top box 108), such as a personal computer, tablet device, etc. Trigger device 102 may include various other controls that are not shown, such as touchscreens, keypads, etc. Trigger command input 116 may be a physical input, such as a button, a virtual input, such as a touchscreen icon, or may be a gesture performed by the user that is recorded. In one example, once associating the complex navigation with trigger command input 116, the user can recall the complex navigation with a single command. That it, a user can select trigger command input 116 on input device 102 and the first instance of content and the second instance of content are automatically displayed in a state in which they were saved. In one embodiment, a user does not have to perform any other actions to recall the complex navigation. For example, if the complex navigation is assigned to a physical button (e.g., a favorites button on a remote control), then the user can pick up trigger device 102 and select the physical button. The user did not have to open any applications, navigate any menus, or perform any actions in a software program. The same may be true for a virtual input, which may always be displayed in an interface, or a gesture that may always be performed. In other examples, a user may have to navigate to select a menu to display a virtual input for trigger command input 116.

When a user wants to save a complex navigation, trigger device 102 may send a trigger initiation command input 118 that sends a trigger initiation command to set-top box 108. The trigger initiation command indicates that a complex navigation should be assigned to a trigger command. Trigger initiation command input 118 may be another input similar to trigger command input 116 (or trigger command input 116 may be used to send the trigger initiation command). Once set-top box 108 receives the trigger initiation command, set-top box 108 knows that a trigger command is going to be received. Trigger device 102 can then send the trigger command that will used to recall the complex navigation. Although one trigger command input 116 is shown, a user may have a choice between multiple trigger command inputs (e.g., multiple physical buttons or virtual buttons). In one embodiment, a user may select trigger command input 116. In this case, trigger device 102 communicates the trigger command to set-top box 108 via a communication method, such as infrared (IR), radio frequency (RF), or through a wired network. Set-top box 108 then associates a state of the complex navigation with the trigger command. The state is information that can be used to reproduce the first instance of content and the second instance of content. For example, the state may be time in a movie and a search result. In one example, each trigger command input 116 may be associated with an identifier. Set-top box 108 may store the identifier for the trigger command in association with the state.

After associating the trigger command with the complex navigation, at a later time, a user may automatically recall the complex navigation. For example, a user may select trigger command input 116. In response, trigger device 102 sends the trigger command to set-top box 108. Once receiving the trigger command, set-top box 108 retrieves the complex navigation, and automatically outputs the first instance of content and the second instance of content in a state in which the user saved the complex navigation. For example, set-top box 108 may output the movie at the same point at which the user paused the movie and also output the search result that was displayed when the trigger command was received. Accordingly, a single command may be used by a user to recall a complex navigation that requires multiple actions to be performed to output the first instance of content and the second instance of content. In one example, a user had to perform no other actions except for selecting trigger command input 116. For example, a user picks up a remote control and selects a button assigned to the complex navigation.

FIG. 2 depicts a simplified flowchart 200 of a method for storing a trigger command according to one embodiment. At 202, the method receives a complex navigation. The complex navigation may include multiple actions that are taken in response to user input. The actions may retrieve multiple instances of content in multiple windows/applications. As discussed above, the complex navigation may open multiple instances of content in multiple windows 112/applications.

At 204, the method outputs the multiple instances of content based on the complex navigation. For example, set-top box 108 may display the first instance of the content in window 112-1 and the second instance of the content in window 112-2.

At some point, the user may want to save the complex navigation and thus starts the trigger command initiation process. At 206, set-top box 108 receives a trigger initiation command, which indicates to set-top box 108 that a trigger command should be configured to recall a complex navigation. In one embodiment, user interface 114 may output a menu that allows a user to select a state of the complex navigation to save. For example, multiple instances of content may be displayed in multiple applications on user interface 114. A user may select which content to associate with the trigger command. For example, a user may select that a point in a movie should be saved, a search query should be saved, or the state of user interface 114 at a certain point in time should be saved.

At 208, set-top box 108 receives a signal for the trigger command. For example, a user may select trigger command input 116 and trigger device 102 sends the trigger command to set-top box 108. This may send an identifier for the trigger command to set-top box 108. At 210, set-top box 108 stores the trigger command in association with the state of the complex navigation. For example, set-top box 108 may store a universal resource identifier (URI) that includes information to allow set-top box 108 to recall the instances of content in multiple applications. In one example, an elapsed time in a movie and a search result are stored in association with the trigger command.

Once the trigger command is associated with a complex navigation, at a later time, the user may recall the complex navigation by selecting trigger command input 116 on trigger device 102. FIG. 3 depicts a simplified flowchart 300 of a method for recalling a complex navigation according to one embodiment. At 302, set-top box 108 receives the trigger command from trigger device 102. The trigger command was input based on a single action by a user, such as the user selected trigger command input 116 on input device 102. At 304, set-top box 108 retrieves the stored state for the complex navigation. For example, set-top box 108 may have stored the URI for the complex navigation. The URI may include any information needed to re-create the state of the complex navigation, such as information to load a movie at a certain point, load a playlist, display a search result, etc. This may involve multiple actions that need to be taken by set-top box 108 to re-create the state of the complex navigation.

At 306, set-top box 108 causes output of the multiple instances of content to reproduce the state of the complex navigation. For example, set-top box 108 may open multiple applications and display multiple instances of content in the state in which the content was saved for the trigger command. Accordingly, a user may perform a single action, such as selecting trigger command input 116, and have multiple instances of content for a complex navigation recalled.

FIG. 4 depicts a more detailed example of set-top box 108 according to one embodiment. It will be understood that functions described with respect to set-top box 108 may be distributed in or performed by other devices. A trigger initiator 402 receives a trigger initiation command. This indicates to trigger initiator 402 that a trigger command will be received for association with a state of a complex navigation. Meanwhile, a state manager 404 may have received a complex navigation that included multiple actions to output multiple instances of content on multiple applications. State manager 404 can re-create the state of the complex navigation. Also, in one embodiment, state manager 404 receives user input to specify which parts of the complex navigation to save for the state.

Trigger initiator 402 then receives a trigger command from trigger device 102. Trigger initiator 402 and state manager 404 store the trigger command in association with the state of the complex navigation in storage 406. The state may be stored in a URI as discussed above.

At another time, a user may decide to recall the complex navigation and selects trigger command input 116 on trigger device 102 and trigger device 102 then sends the trigger command to trigger processor 408. A trigger processor 408 then receives the trigger command from trigger device 102. Once receiving the trigger command, trigger processor 408 looks up the trigger command in storage 406, and retrieves the state that is associated with the trigger command. For example, trigger processor 408 retrieves the URI.

Content processor 410 then receives the state from trigger processor 408 and can recall the state of the complex navigation. For example, content processor 410 can access the URI, and perform multiple actions to re-create the state of the complex navigation. As described above, content processor 410 may open multiple applications and retrieve different instances of content in the respective applications. Content processor 410 may then output the instances of content on user interface 114.

FIG. 5 depicts an example of the information stored for the state of the complex navigation according to one embodiment. At 502, a trigger command #1 is stored based on receiving the trigger command from trigger command input 116. A URI #1 is stored in association with trigger command #1. The URI includes information to recall the state of the complex navigation. For example, at 504, an elapsed time for a movie is stored. Additionally, information for a link for a search result is stored in URI #1 at 506.

Although the above description discussed performing the complex navigation on output device 104, another computing device may be used to perform the complex navigation. FIG. 6 shows a system 600 for recalling the state of a complex navigation performed on a second computing device 602 according to one embodiment. Second computing device 602 may be a tablet device or other computing device, such as a smartphone, personal computer, desktop computer, etc. Second computing device 602 includes a user interface 604 that displays the first instance of content and the second instance of content in first and second windows 606-1 and 606-2, respectively.

A user may provide the trigger initiation command using second computing device 602 in this example. For example, a user may select a state of instances of content to save for the complex navigation on second computing device 602, and then send the trigger initiation command to set-top box 108. In another example, a user may still use trigger device 102 to send the trigger initiation command using trigger initiation command input 118. Once the trigger initiation command is received, trigger device 102 may send the trigger command to set-top box 108 using trigger command input 116. In addition, second computing device 602 may send the state of the complex navigation to set-top box 108. Once receiving both the trigger command and the state, set-top box 108 can then store the trigger command with the state of the complex navigation. At a later time, as described above, set-top box 108 may recall the state of the complex navigation when the trigger command is received. Set-top box 108 may then display the instances of content for the complex navigation on display device 106. Alternatively, set-top box 108 may cause display of the instances of content on second computing device 602, or another different computing device.

Accordingly, a user can configure a trigger command to recall the state of a complex navigation. This allows a user to recall the state without performing multiple actions. For example, a user needs to perform no other actions other than select trigger command input 116. Thus, a method of assigning the state of the complex navigation to a trigger command that can be selected with a single action simplifies the process of recalling the state of the complex navigation.

FIG. 7 illustrates an example of a special purpose computer system 700 configured with a trigger command configuration system according to one embodiment. Computer system 700 includes a bus 702, network interface 704, a computer processor 706, a memory 708, a storage device 710, and a display 712.

Bus 702 may be a communication mechanism for communicating information. Computer processor 704 may execute computer programs stored in memory 708 or storage device 708. Any suitable programming language can be used to implement the routines of particular embodiments including C, C++, Java, assembly language, etc. Different programming techniques can be employed such as procedural or object oriented. The routines can execute on a single computer system 700 or multiple computer systems 700. Further, multiple processors 706 may be used.

Memory 708 may store instructions, such as source code or binary code, for performing the techniques described above. Memory 708 may also be used for storing variables or other intermediate information during execution of instructions to be executed by processor 706. Examples of memory 708 include random access memory (RAM), read only memory (ROM), or both.

Storage device 710 may also store instructions, such as source code or binary code, for performing the techniques described above. Storage device 710 may additionally store data used and manipulated by computer processor 706. For example, storage device 710 may be a database that is accessed by computer system 700. Other examples of storage device 710 include random access memory (RAM), read only memory (ROM), a hard drive, a magnetic disk, an optical disk, a CD-ROM, a DVD, a flash memory, a USB memory card, or any other medium from which a computer can read.

Memory 708 or storage device 710 may be an example of a non-transitory computer-readable storage medium for use by or in connection with computer system 700. The computer-readable storage medium contains instructions for controlling a computer system to be operable to perform functions described by particular embodiments. The instructions, when executed by one or more computer processors, may be operable to perform that which is described in particular embodiments.

Computer system 700 includes a display 712 for displaying information to a computer user. Display 712 may display a user interface used by a user to interact with computer system 700.

Computer system 700 also includes a network interface 704 to provide data communication connection over a network, such as a local area network (LAN) or wide area network (WAN). Wireless networks may also be used. In any such implementation, network interface 704 sends and receives electrical, electromagnetic, or optical signals that carry digital data streams representing various types of information.

Computer system 700 can send and receive information through network interface 704 across a network 714, which may be an Intranet or the Internet. Computer system 700 may interact with other computer systems 700 through network 714. In some examples, client-server communications occur through network 714. Also, implementations of particular embodiments may be distributed across computer systems 700 through network 714.

Particular embodiments may be implemented in a non-transitory computer-readable storage medium for use by or in connection with the instruction execution system, apparatus, system, or machine. The computer-readable storage medium contains instructions for controlling a computer system to perform a method described by particular embodiments. The computer system may include one or more computing devices. The instructions, when executed by one or more computer processors, may be operable to perform that which is described in particular embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. The above examples and embodiments should not be deemed to be the only embodiments, and are presented to illustrate the flexibility and advantages of particular embodiments as defined by the following claims. Based on the above disclosure and the following claims, other arrangements, embodiments, implementations and equivalents may be employed without departing from the scope hereof as defined by the claims.

What is claimed is:

1. A method comprising:
receiving, by a computing device, a trigger initiation command for configuring a trigger command;
receiving, by the computing device, the trigger command from a trigger device that is separate from the computing device, the trigger command based on a selection of a trigger command input on the trigger device;
determining, by the computing device, a state of a complex navigation, the complex navigation requiring multiple actions to output content associated with the state;
storing, by the computing device, an association between the state of the complex navigation and the trigger command;
receiving, by the computing device, the trigger command from the trigger device, the trigger command being sent based on a single input selecting the trigger command input; and
recalling, by the computing device, the state of the complex navigation to output the content.

2. The method of claim 1, wherein the trigger command is sent via a wireless communication from the trigger device.

3. The method of claim 1, wherein the single input comprises a selection of the trigger command input on the trigger device that does not require opening any applications on the trigger device.

4. The method of claim 1, further comprising:
receiving input regarding the state of the complex navigation;
determining information that can be used to automatically recall the state of the complex navigation to output the content; and
associating the information with the trigger command.

5. The method of claim 4, further comprising:
outputting a menu with options to select the state of the complex navigation; and
receiving a selection of state to save for the complex navigation through the menu.

6. The method of claim 1, wherein:
the content comprises multiple instances of content, and
the multiple instances of content are recalled and output based on receiving the trigger command.

7. The method of claim 6, wherein multiple applications are opened to recall and output the multiple instances of content.

8. The method of claim 1, wherein recalling comprises performing a plurality of actions to recall and output the content.

9. The method of claim 1, wherein the complex navigation is performed on the computing device before receiving the trigger command.

10. The method of claim 1, further comprising:
receiving the state for the complex navigation from another computing device in which the complex navigation was performed; and
associating the received state with the trigger command.

11. The method of claim 1, wherein the state of the complex navigation is recalled to output the content based on the trigger command input without a user having to perform any other action associated with the trigger device or the computing device.

12. The method of claim 1, wherein the trigger command input comprises a physical input or a virtual input.

13. A non-transitory computer-readable storage medium containing instructions that, when executed, control a computer system to be configured for:
receiving a trigger initiation command for configuring a trigger command;
receiving the trigger command from a trigger device separate from the computing device, the trigger command based on a selection of a trigger command input on the trigger device;
determining a state of a complex navigation, the complex navigation requiring multiple actions to output content associated with the state;
storing an association between the state of the complex navigation and the trigger command;
receiving the trigger command from the trigger device, the trigger command being sent based on a single input selecting the trigger command input; and
recalling the state of the complex navigation to output the content.

14. The non-transitory computer-readable storage medium of claim 13, wherein the trigger command is sent via a wireless communication from the trigger device.

15. The non-transitory computer-readable storage medium of claim 13, wherein the single input comprises a selection of the trigger command input on the trigger device that does not require opening any applications on the trigger device.

16. The non-transitory computer-readable storage medium of claim 13, further comprising:
receiving input regarding the state of the complex navigation;
determining information that can be used to automatically recall the state of the complex navigation to output the content; and
associating the information with the trigger command.

17. The non-transitory computer-readable storage medium of claim 13, wherein:
the content comprises multiple instances of content, and
the multiple instances of content are recalled and output based on receiving the trigger command.

18. The non-transitory computer-readable storage medium of claim 17, wherein multiple applications are opened to recall and output the multiple instances of content.

19. The non-transitory computer-readable storage medium of claim 13, wherein recalling comprises performing a plurality of actions to recall and output the content.

20. A method comprising:
receiving, by a computing device, a first input for a trigger initiation command for configuring a trigger command;
sending, by the computing device, the trigger initiation command to a secondary device;
receiving, by the computing device, a second input for the trigger command, the trigger command based on a selection of a trigger command input;
sending, by the computing device, the trigger command to the secondary device, wherein the secondary device saves a state of a complex navigation requiring multiple actions to output content associated with the state and the secondary device associates the state with the trigger command;
receiving, by the computing device, a third input for the trigger command, the trigger command based on a single input selecting the trigger command input; and
sending, by the computing device, the trigger command to the secondary device, wherein the secondary device recalls the state of the complex navigation to output the content based on the receiving of the trigger command.
